(19) United States
(12) Patent Application Publication
(10) Pub. No.: US 2014/0003098 A1
(43) Pub. Date: Jan. 2, 2014

(54) PWM CONTROL CIRCUIT FOR DC-DC CONVERTER, FLYBACK CONVERTER, AND METHOD OF CONTROLLING PWM OF DC-DC CONVERTER

(71) Applicant: Samsung Electro-Mechanics Co., Ltd., Gyeonggi-do (KR)

(72) Inventors: Deuk Hee Park, Gyeonggi-do (KR); Sang Hyun Cha, Gyeonggi-do (KR); Youn Joong Lee, Gyeonggi-do (KR); Chang Seok Lee, Gyeonggi-do (KR)

(21) Appl. No.: 13/927,053

(22) Filed: Jun. 25, 2013

(30) Foreign Application Priority Data
Jun. 28, 2012 (KR) 10-2012-0070052

(51) Int. Cl. H02M 3/335

(52) U.S. Cl. CPC H02M 3/33507
USPC 363/21.16

(57) ABSTRACT

Provided is a PWM control circuit for a DC-DC converter, flyback converter and a method of controlling a PWM of a DC-DC converter. The PWM control circuit for the DC-DC converter includes a current sensing unit configured to sense a primary-side current, a zero-current detecting unit configured to detect a zero-current from a secondary-side auxiliary winding, a time calculating unit configured to receive a main switch control signal and an output signal of the zero-current detecting unit to calculate a time from an OFF point of a main switch to a point that the secondary-side current becomes zero, and a control unit configured to receive an output signal of the current sensing unit and time information produced by the time calculating unit to calculate a secondary-side output voltage and perform PWM control with respect to the main switch according to the calculated secondary-side output voltage.

### CROSS-REFERENCE TO RELATED APPLICATIONS

This application claims the benefit of Korean Patent Application No. 10-2012-0070052 filed with the Korea Intellectual Property Office on Jun. 28, 2012, the disclosure of which is incorporated herein by reference.

### BACKGROUND OF THE INVENTION

1. Field of the Invention

The present invention relates to a PWM control circuit for a DC-DC converter, a flyback converter and a method of controlling a PWM of a DC-DC converter, and more particularly, to a PSR (primary side regulation) type PWM control circuit for a DC-DC converter, a flyback converter and a method of controlling a PWM of a DC-DC converter.

2. Description of the Related Art

An application such as an adapter should be constant-current/constant-voltage (CC/CV) controlled. In order to perform CC/CV control in a DC-DC converter, conventionally, a feedback signal is received from a secondary-side to perform the control.

When a conventional flyback converter is used, while a feedback is received from the secondary-side to perform the CC/CV control, such a structure has a disadvantage that the secondary-side circuit is complex. Since an insulating-type DC-DC converter, for example, a flyback converter is insulated from a transformer, the feedback for CC/CV control requires circuits such as a secondary-side circuit, a photo-coupler, and so on, complicating the feedback and increasing a material cost.

In order to improve this, a PSR type CC/CV control is needed.

### RELATED ART DOCUMENT

### Patent Document

(Patent Document 1) U.S. Pat. No. 6,853,563 (published on Feb. 8, 2005)
(Patent Document 2) US Patent Laid-open Publication No. 20100128501 (published on May 27, 2010)

### SUMMARY OF THE INVENTION

The present invention has been invented in order to overcome the above-described problems and it is, therefore, an object of the present invention to provide a technique of sensing a voltage of a secondary-side through a PSR (primary side regulation) method in a DC-DC converter operated between a critical conductive mode (CRM) and a discontinuous conductive mode (DCM), for example, a flyback converter circuit.

In accordance with one aspect of the present invention to achieve the object, there is provided a PWM control circuit for a DC-DC converter including a current sensing unit configured to sense a primary-side current; a zero-current detecting unit configured to detect a zero-current from a secondary-side auxiliary winding; a time calculating unit configured to receive a main switch control signal and an output signal of the zero-current detecting unit to calculate a time from an OFF point of a main switch to a point that the secondary-side current becomes zero; and a control unit configured to receive an output signal of the current sensing unit and time information produced by the time calculating unit to calculate a secondary-side output voltage and perform PWM control with respect to the main switch according to the calculated secondary-side output voltage.

In addition, in one example, the control unit may include a calculating unit configured to receive the output signal of the current sensing unit and the time information produced by the time calculating unit to calculate the secondary-side output voltage; and a PWM control unit configured to perform the PWM control with respect to the main switch according to the secondary-side output voltage calculated by the calculating unit.

Here, in one example, the calculating unit may include a divider configured to divide the signal information obtained from the output of the current sensing unit by the time information produced from the time calculating unit.

Further, in one example, the secondary-side output voltage Vₒᵤₜ may be calculated according to the following equation

Vₒᵤₜ=n×((I_{cspeak}−I_{csmin})×Lₘ)/T_{dmg}

wherein n is a winding ratio between a primary-side and a secondary-side, I_{cspeak} is a peak value of a primary-side sensed current, I_{csmin} is a minimum value of the primary-side sensed current in an ON section of the main switch, T_{dmg} is a time from an OFF point of the main switch calculated by the time calculating unit to a point that the secondary-side current becomes zero, and Lₘ is a value of a primary-side magnetized inductance.

Here, in one example, a minimum value of the primary-side sensed current may be ‘0’.

In another example, the PWM control unit may include an error amplification unit configured to amplify an error between the secondary-side output voltage calculated by the calculating unit and a reference voltage; a duty determination unit configured to compare the output signal of the error amplification unit with a reference wave type signal to determine a duty; and a switch driving unit configured to receive the output of the duty determination unit to apply a PWM control signal to the main switch.

In addition, in one example, the PWM control circuit for the DC-DC converter may further include a main switch configured to perform an ON-OFF operation according to the PWM control of the control unit.

According to still another example, the PWM control circuit for the DC-DC converter may be a flyback converter control circuit.

In accordance with another aspect of the present invention to achieve the object, there is provided a flyback converter including a transformer unit provided with a primary-side winding, a secondary-side main winding and a secondary-side auxiliary winding; a main switch connected to the primary-side winding to perform an ON-OFF operation and transmit a primary-side input voltage to the transformer unit; a secondary output unit connected to the secondary-side main winding of the transformer unit to provide a secondary-side output; a current sensing unit configured to sense a primary-side current; a zero-current detecting unit configured to detect a zero-current from the secondary-side auxiliary winding; a time calculating unit configured to receive a control signal of the main switch and an output signal of the zero-current detecting unit to calculate a time from an OFF point of the main switch to a point that the secondary-side current becomes zero; and a control unit configured to receive an output signal of the current sensing unit and time information produced by the time calculating unit to calculate a secondary-side output voltage and perform PWM control with respect to the main switch according to the calculated secondary-side output voltage.

In addition, the control unit may include a calculating unit configured to receive the output signal of the current sensing unit and the time information produced by the time calculating unit to calculate a secondary-side output voltage; and a PWM control unit configured to perform PWM control with respect to the main switch according to the secondary-side output voltage calculated by the calculating unit.

Here, in one example, the calculating unit may include a divider configured to divide the signal information obtained from the output of the current sensing unit by the time information produced from the time calculating unit.

Further, in one example, the secondary-side output voltage Vₒᵤₜ may be calculated according to the following equation

Vₒᵤₜ=n×((I_{cspeak}−I_{csmin})×Lₘ)/T_{dmg}

wherein n is a winding ratio between a primary-side winding and a secondary-side main winding, I_{cspeak} is a peak value of a primary-side sensed current, I_{csmin} is a minimum value of the primary-side sensed current in an ON section of the main switch, T_{dmg} is a time from an OFF point of the main switch calculated by the time calculating unit to a point that the secondary-side current becomes zero, and Lₘ is a value of a primary-side magnetized inductance.

Furthermore, in one example, the PWM control unit may include an error amplification unit configured to an error between the secondary-side output voltage calculated by the calculating unit and a reference voltage; a duty determination unit configured to compare an output signal of the error amplification unit with a reference wave type signal to determine a duty; and a switch driving unit configured to receive an output of the duty determination unit to apply a PWM control signal to the main switch.

In accordance with still another aspect of the present invention to achieve the object, there is provided a method of controlling a PWM of a DC-DC converter including a current sensing step of sensing a primary-side current; a zero current detecting step of detecting a zero-current from a secondary-side auxiliary winding; a time calculating step of receiving a main switch control signal and a signal detected by the zero current detecting step and calculate a time from an OFF point of a main switch to a point that a secondary-side current becomes zero; and a control step of receiving an output signal sensed and output in the current sensing step and time information produced in the time calculating step to calculate a secondary-side output voltage and perform PWM control with respect to the main switch according to the secondary-side output voltage.

In addition, in one example, the control step may include a calculating step of receiving the output signal sensed and output in the current sensing step and the time information produced in the time calculating step to calculate the secondary-side output voltage; and a PWM control step of performing the PWM control with respect to the main switch according to the secondary-side output voltage calculated in the calculating step.

Here, in one example, in the calculating step, the secondary-side output voltage Vₒᵤₜ may be calculated according to the following equation

Vₒᵤₜ=n×((I_{cspeak}−I_{csmin})×Lₘ)/T_{dmg}

wherein n is a winding ratio between a primary-side and a secondary-side, I_{cspeak} is a peak value of a primary-side sensed current, I_{csmin} is a minimum value of the primary-side sensed current in an ON section of the main switch, T_{dmg} is a time from an OFF point of the main switch calculated by the time calculating unit to a point that the secondary-side current becomes zero, and Lₘ is a value of a primary-side magnetized inductance.

In addition, in one example, the PWM control step may include an error amplifying step of amplifying an error between the secondary-side output voltage calculated in the calculating step and a reference voltage; a duty determination step of comparing the output signal amplified and output in the error amplifying step with a reference wave type signal to determine a duty; and a switch driving step of receiving a duty output determined in the duty determination step to apply a PWM control signal to the main switch.

Further, according to one example, the method of controlling the PWM of the DC-DC converter may be a flyback converter control method.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram schematically showing a PWM control circuit for a DC-DC converter according to an embodiment of the present invention;

FIG. 2 is a circuit diagram schematically showing a flyback converter including a PWM control circuit for a DC-DC converter according to another embodiment of the present invention;

FIG. 3 is a flowchart schematically showing a method of controlling a PWM of a DC-DC converter according to still another embodiment of the present invention; and

FIG. 4 is a flowchart schematically showing a part of a method of controlling a PWM of a DC-DC converter according to still another embodiment of the present invention.

### DETAILED DESCRIPTION OF THE PREFERABLE EMBODIMENTS

Hereinafter, exemplary embodiments of the present invention will be described in detail. The following embodiments are described in order to enable those of ordinary skill in the art to embody and practice the present invention. To clearly describe the present invention, parts not relating to the description are omitted from the drawings.

It will be understood that when an element or layer is referred to as being “on” or “connected to” another element or layer, it can be directly on or directly connected to the other element or layer, or intervening elements or layers may be present, unless the context clearly indicates otherwise.

Terms used herein are provided for explaining embodiments of the present invention, not limiting the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, motions, and/or devices, but do not preclude the presence or addition of one or more other components, motions, and/or devices thereof.

First, a PWM control circuit for a DC-DC converter of a first embodiment of the present invention will be described in detail with reference to the accompanying drawings. Here, reference numerals not shown in a reference drawing may be reference numerals in another drawing showing the same configuration.

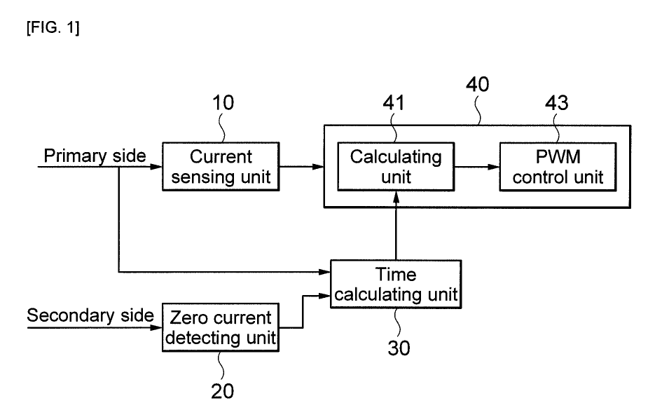

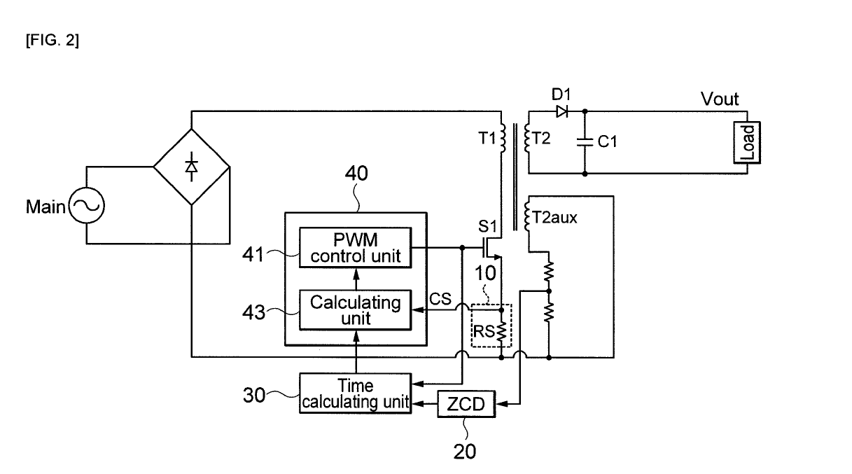

FIG. 1 is a block diagram schematically showing the PWM control circuit for the DC-DC converter according to an embodiment of the present invention, and FIG. 2 is a circuit diagram schematically showing a flyback converter including a PWM control circuit for a DC-DC converter according to another embodiment of the present invention.

Referring to FIG. 1, the PWM control circuit for the DC-DC converter according to the first embodiment of the present invention may include a current sensing unit 10, a zero-current detecting unit 20, a time calculating unit 30 and a control unit 40. In addition, according to one example, the PWM control circuit for the DC-DC converter may include a main switch S1.

For example, the DC-DC converter may be an insulating-type DC-DC converter. In one example, the PWM control circuit for the DC-DC converter may be a flyback converter control circuit.

Referring to FIG. 1, the current sensing unit 10 senses a primary-side current. For example, a sensing resistance Rs may be installed at a lower end of the main switch S1 to measure a voltage applied to the sensing resistance Rs, sensing a primary-side current. Here, the current sensing unit 10 senses a peak value of the primary-side current.

Next, the zero-current detecting unit 20 of FIG. 1 detects a zero-current from a secondary-side auxiliary winding T2aux. Time information that the zero-current is detected by the zero-current detecting unit 20 is provided to a time calculating unit 30. The current is gradually reduced in the secondary-side auxiliary winding T2aux during an OFF operation of the main switch S1, and thus, the current flows in an opposite direction so that a time that the current passes a zero point is detected. That is, the zero-current detecting unit 20 detects a point at which a direction of the current is changed in the secondary-side auxiliary winding T2aux.

Next, the time calculating unit 30 of FIG. 1 will be described. The time calculating unit 30 receives output signals of the main switch S1 control signal and the zero-current detecting unit 20 to calculate a time from the OFF point of the main switch S1 to a point at which the secondary-side current becomes zero. A magnetized current of the primary-side from the ON point to the OFF point of the main switch S1 is increased from a minimum point, i.e., substantially ‘0’ to a peak point. Since energy accumulated in a primary-side magnetized inductance is transmitted to the secondary-side from the OFF point of the main switch S1 to the ON point of the main switch S1, the primary-side magnetized current is reduced to the minimum value at the peak value. For example, the primary-side magnetized current is reduced to substantially ‘0’ at the peak value. Here, the peak value and the minimum value of the primary-side magnetized current correspond to the peak value and the minimum value of the primary-side current. In addition, the current in the secondary-side auxiliary winding T2aux passes the zero point at the ON point of the main switch S1. Accordingly, the primary-side current is reduced to the minimum value at the peak value during the time from the OFF point of the main switch S1 to the zero-current point of the secondary-side auxiliary winding T2aux. For example, the primary-side current is reduced to substantially ‘0’ at the peak value during the time from the OFF point of the main switch S1 to the zero-current point of the secondary-side auxiliary winding T2aux. Here, the variation amount of the primary-side current is multiplied by the magnetized inductance value and is divided by the time Tdmg from the OFF point of the main switch S1 to the zero-current point of the secondary-side auxiliary winding T2aux, calculating a secondary-side output voltage. Since the main switch S1, which is turned OFF, can be turned ON after the secondary-side current is zero, the secondary-side output voltage is calculated by the time Tdmg from the OFF point of the main switch S1 to the zero-current point of the secondary-side auxiliary winding T2aux.

Next, the control unit 40 of FIG. 1 will be described. The control unit 40 receives the output signal of the current sensing unit 10 and the time information produced by the time calculating unit 30 to calculate the secondary-side output voltage. In addition, the control unit 40 performs the PWM control with respect to the main switch S1 according to the secondary-side output voltage.

Further, referring to FIG. 1 and/or 2, in one example, the control unit 40 may include a calculating unit 41 and a PWM control unit 43. Here, the calculating unit 41 receives the output signal of the current sensing unit 10 and the time information produced by the time calculating unit 30 to calculate the secondary-side output voltage.

Here, while not shown, in one example, the calculating unit 41 may include a divider (not shown) configured to divide the signal information obtained from the output of the current sensing unit 10 by the time information produced by the time calculating unit 30.

In addition, in another example, the secondary-side output voltage Vₒᵤₜ can be calculated according to the following Equation (1).

Vₒᵤₜ=n×((I_{cspeak}−I_{csmin})×Lₘ)/T_{dmg} Equation (1)

Here, n is a winding ratio between the primary-side and the secondary-side, I_{cspeak} is a peak value of the primary-side sensed current, and I_{csmin} is a minimum value of the primary-side sensed current in an ON section of the main switch S1. For example, here, the minimum value I_{csmin} of the primary-side sensed current is substantially ‘0’. In this case, Equation (1) can be expressed by the following Equation (2).

Vₒᵤₜ=n×(I_{cspeak}×Lₘ)/T_{dmg} Equation (2)

In addition, T_{dmg} is a time from the OFF point of the main switch S1 produced by the time calculating unit 30 to a point at which the secondary-side current becomes zero, and Lₘ is a value of the primary-side magnetized inductance.

Next, referring to FIG. 1 and/or 2, the PWM control unit 43 performs the PWM control with respect to the main switch S1 according to the secondary-side output voltage calculated by the calculating unit 41.

While not shown, in one example, the PWM control unit 43 may include an error amplification unit, a duty determination unit and a switch driving unit. Here, the error amplification unit (not shown) compares the secondary-side output voltage calculated by the calculating unit 41 with a reference voltage. The error amplification unit may be constituted by an error amplifier. A signal output from the error amplification unit may be compared with a reference wave type signal, for example, a ramp wave, a sawtooth wave, a triangle wave, and so on, to adjust a duty. The duty determination unit (not shown) compares the output signal of the error amplification unit with the reference wave type signal to determine the duty. The duty determination unit includes a comparator, and compares the reference wave type signal with the output signal of the error amplification unit to adjust the duty. Then, the switch driving unit (not shown) receives an output of the duty determination unit to apply the PWM control signal to the main switch S1. For example, the switch driving unit may be constituted by a flip-flop circuit, or a flip-flop circuit and a CMOS transistor.

Referring to FIG. 2, the PWM control circuit for the DC-DC converter according to one example may further include the main switch S1. Here, the main switch S1 performs an ON-OFF operation according to the PWM control of the control unit 40.

Next, a flyback converter according to a second embodiment of the present invention will be described in detail with reference to the accompanying drawings. Here, the PWM control circuit for the DC-DC converter according to the first embodiment and FIG. 1 will be referenced, and overlapping description will not be repeated.

FIG. 2 is a circuit diagram schematically showing a flyback converter according to still another embodiment of the present invention.

Referring to FIG. 2, the flyback converter according to the second embodiment of the present invention may include a transformer unit, a main switch S1, a secondary output unit, a current sensing unit 10, a zero-current detecting unit 20, a time calculating unit 30 and a control unit 40. The respective elements will be described below.

In FIG. 2, the transformer unit includes a primary-side winding T1, a secondary-side main winding T2 and a secondary-side auxiliary winding T2aux.

The main switch S1 of FIG. 2 is connected to the primary-side winding to perform an ON-OFF operation. According to the ON-OFF operation of the main switch S1, a primary-side input voltage is transmitted to the transformer unit. Specifically, upon the ON operation of the main switch S1, energy is accumulated to a magnetized inductance of the primary-side winding, and when the main switch S1 is turned OFF, the energy accumulated to the magnetized inductance of the primary-side winding is transmitted to the secondary-side winding to flow the secondary-side current.

Next, the secondary output unit of FIG. 2 is connected to the secondary-side main winding of the transformer unit to provide a secondary-side output. Referring to FIG. 2, the secondary output unit may include a rectifying diode D1, a smoothing capacitor C1 and a load. Upon the ON operation of the main switch S1, since the rectifying diode D1 blocks a flow of the current in a reverse direction, the secondary-side current does not flow, but the energy stored in the smoothing capacitor C1 in a normal state is output as a load. Meanwhile, the energy accumulated at the primary-side during the OFF operation of the main switch S1 is transmitted to the secondary-side to flow the secondary-side current through the rectifying diode D1, accumulating the energy in the smoothing capacitor C1.

Next, the current sensing unit 10 of FIG. 2 senses the primary-side current. For example, a sensing resistance Rs may be installed at a lower end of the main switch S1 to measure a voltage applied to the sensing resistance Rs, sensing the primary-side current. Here, the current sensing unit 10 senses a peak value of the primary-side current.

In addition, the zero-current detecting unit 20 of FIG. 2 detects a zero-current from the secondary-side auxiliary winding T2aux. Time information that the zero-current is detected by the zero-current detecting unit 20 is provided to the time calculating unit 30. When the main switch S1 is turned ON, the current flowing through the secondary-side auxiliary winding T2aux during the OFF operation of the main switch S1 flows in a reverse direction, and a time that the current passes the zero point is detected.

Next, the time calculating unit 30 of FIG. 2 will be described. The time calculating unit 30 receives a control signal of the main switch S1 and an output signal of the zero-current detecting unit 20 to calculate a time from the OFF point of the main switch S1 to a point that the secondary-side current becomes zero. Since the energy accumulated to the primary-side magnetized inductance from the OFF point of the main switch S1 to the ON point of the main switch S1 is transmitted to the secondary-side, the primary-side magnetized current is reduced to a minimum value, for example, substantially ‘0’ at the peak value, and the current in the secondary-side auxiliary winding T2aux passes the zero point at the ON point of the main switch S1. Accordingly, during the time from the OFF point of the main switch S1 to the zero-current point of the secondary-side auxiliary winding T2aux, the primary-side current is reduced to the minimum value, for example, substantially ‘0’ at the peak value. Here, a variation amount of the primary-side current is multiplied by the magnetized inductance value and is divided by the time Tdmg from the OFF point of the main switch S1 to the zero-current point of the secondary-side auxiliary winding T2aux, calculating the secondary-side output voltage.

Next, the control unit 40 of FIG. 2 will be described. The control unit 40 of the flyback converter receives the output signal of the current sensing unit 10 and the time information produced by the time calculating unit 30 to calculate the secondary-side output voltage. In addition, the control unit 40 performs the PWM control with respect to the main switch S1 according to the secondary-side output voltage.

Referring to FIG. 2, reviewing one example, the control unit 40 of the flyback converter may include a calculating unit 41 and a PWM control unit 43. Here, the calculating unit 41 receives the output signal of the current sensing unit 10 and the time information produced by the time calculating unit 30 to calculate the secondary-side output voltage.

Here, while not shown, in one example, the calculating unit 41 may include a divider for dividing the signal information obtained from the output of the current sensing unit 10 by the time information produced by the time calculating unit 30.

In addition, in one example, the secondary-side output voltage Vₒᵤₜ can be calculated according to Equation (1). Here, in Equation (1), I_{csmin} may be substantially ‘0’ as a minimum value of the primary-side sensed current in an ON section of the main switch S1. In this case, Equation (1) may be expressed as Equation (2).

Then, the PWM control unit 43 performs the PWM control with respect to the main switch S1 according to the secondary-side output voltage calculated by the calculating unit 41.

While not shown, according to one example, the PWM control unit 43 may include an error amplification unit, a duty determination unit and a switch driving unit. Here, the error amplification unit (not shown) amplifies an error between the secondary-side output voltage calculated by the calculating unit 41 and a reference voltage. The duty determination unit (not shown) compares the output signal of the error amplification unit with a reference wave type signal to determine a duty. Then, the switch driving unit (not shown) receives an output of the duty determination unit to apply a PWM control signal to the main switch S1.

Next, a method of controlling a PWM of a DC-DC converter according to a third embodiment of the present invention will be described in detail with reference to the accompanying drawings. Here, the PWM control circuit for the DC-DC converter according to the first embodiment, the flyback converter according to the second embodiment, and FIGS. 1 and 2 will be referenced, and overlapping description will not be repeated.

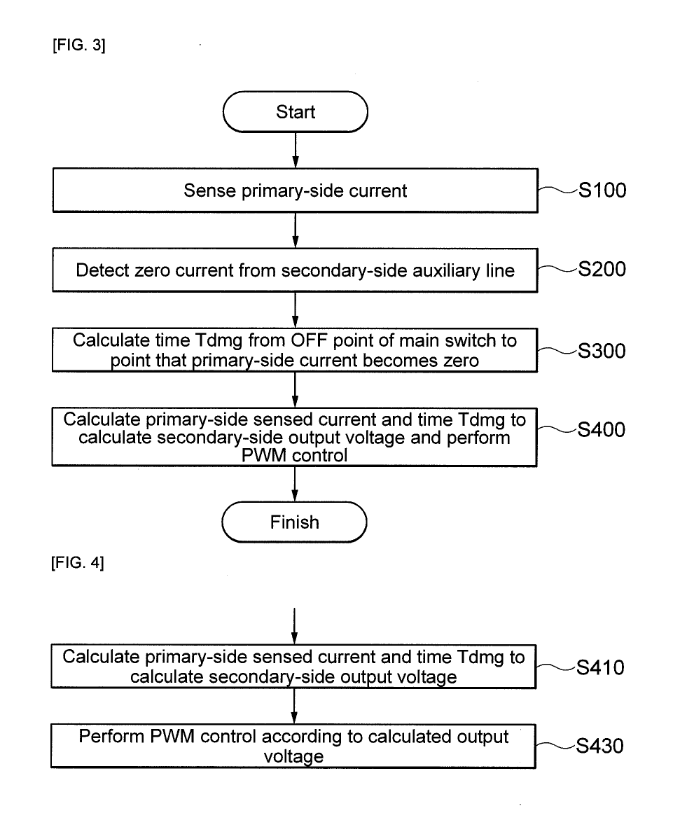

FIG. 3 is a flowchart schematically showing a method of controlling a PWM of a DC-DC converter according to another embodiment of the present invention, and FIG. 4 is a flowchart schematically showing a method of controlling a PWM of a DC-DC converter according to still another embodiment of the present invention.

Referring to FIG. 3, the method of controlling the PWM of the DC-DC converter according to the third embodiment of the present invention may include a current sensing step S100, a zero current detecting step S200, a time calculating step S300 and a control step S400.

Here, according to one example, the method of controlling the PWM of the DC-DC converter may be a PWM control method in the flyback converter.

In FIG. 3, in the current sensing step S100, the primary-side current is sensed. Here, in the current sensing step S100, a peak value of the primary-side current is sensed.

In FIG. 3, in the zero current detecting step S200, a zero-current from the secondary-side auxiliary winding T2aux is detected. In the zero current detecting step S200, time information in which the zero-current is detected is provided to the time calculating step S300 to calculate a time required to calculate the secondary-side output voltage.

Next, in the time calculating step S300 of FIG. 3, a control signal of the main switch S1 and a signal detected in the zero current detecting step S200 are received to calculate a time from the OFF point of the main switch S1 to a point that the secondary-side current becomes zero. During the time from the OFF point of the main switch 51 to the zero-current point of the secondary-side auxiliary winding T2aux, the primary-side current is reduced to a minimum value at the peak value. For example, the primary-side current is reduced to substantially ‘0’ at the peak value. Here, the variation amount of the primary-side current is multiplied by the magnetized inductance value and divided by a time Tdmg from the OFF point of the main switch S1 to the zero-current point of the secondary-side auxiliary winding T2aux, calculating the secondary-side output voltage.

Next, in the control step S400 of FIG. 3, the output signal sensed and output in the current sensing step S100 and the time information produced in the time calculating step S300 are received to calculate the secondary-side output voltage. In addition, in the control step S400 of FIG. 3, the PWM control is performed with respect to the main switch S1 according to the secondary-side output voltage.

Here, referring to FIG. 4, in one example, the control step S400 of FIG. 3 may include a calculating step S410 and a PWM control step S430.

In the calculating step S410 of FIG. 4, the output signal sensed and output in the current sensing step S100 and the time information produced in the time calculating step S300 are received to calculate the secondary-side output voltage.

Here, in one example, in the calculating step S410, the secondary-side output voltage Vₒᵤₜ can be calculated according to Equation (1). Here, in Equation (1), I_{csmin} may be substantially ‘0’ as a minimum value of the primary-side sensed current during the ON section of the main switch S1, and in this case, Equation (1) can be expressed as Equation (2).

Next, in the PWM control step S430 of FIG. 4, the PWM control is performed with respect to the main switch S1 according to the secondary-side output voltage calculated in the calculating step S410.

Here, while not shown, in one example, the PWM control step S430 may include an error amplifying step, a duty determination step and a switch driving step.

Here, in the error amplifying step (not shown), an error between the secondary-side output voltage calculated in the calculating step S410 and the reference voltage is amplified. In addition, in the duty determination step (not shown), the output signal amplified and output in the error amplifying step is compared with the reference wave type signal to determine a duty. Then, in the switch driving step (not shown), the duty output determined in the duty determination step is reduced to apply the PWM control signal to the main switch S1.

As can be seen from the foregoing, according to the embodiments of the present invention, in the DC-DC converter operated between the critical conductive mode (CRM) and the discontinuous conductive mode (DCM), for example, a flyback converter, a voltage of the secondary-side can be sensed through a PSR method.

That is, since the secondary-side voltage is sensed through the PSR method, a circuit is simplified and a material cost is reduced.

Embodiments of the invention have been discussed above with reference to the accompanying drawings. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention.

What is claimed is:

1. A PWM control circuit for a DC-DC converter comprising:
a current sensing unit configured to sense a primary-side current;
a zero-current detecting unit configured to detect a zero-current from a secondary-side auxiliary winding;
a time calculating unit configured to receive a main switch control signal and an output signal of the zero-current detecting unit to calculate a time from an OFF point of a main switch to a point that the secondary-side current becomes zero; and
a control unit configured to receive an output signal of the current sensing unit and time information produced by the time calculating unit to calculate a secondary-side output voltage and perform PWM control with respect to the main switch according to the calculated secondary-side output voltage.

2. The PWM control circuit for the DC-DC converter according to claim 1, wherein the control unit comprises:
a calculating unit configured to receive the output signal of the current sensing unit and the time information produced by the time calculating unit to calculate the secondary-side output voltage; and
a PWM control unit configured to perform the PWM control with respect to the main switch according to the secondary-side output voltage calculated by the calculating unit.

3. The PWM control circuit for the DC-DC converter according to claim 2, wherein the calculating unit comprises a divider configured to divide the signal information obtained from the output of the current sensing unit by the time information produced from the time calculating unit.

4. The PWM control circuit for the DC-DC converter according to claim 2, wherein the secondary-side output voltage Vₒᵤₜ is calculated according to the following equation
Vₒᵤₜ=n×((I_{cspeak}−I_{csmin})×Lₘ)/T_{dmg}
wherein n is a winding ratio between a primary-side and a secondary-side, I_{cspeak} is a peak value of a primary-side sensed current, I_{csmin} is a minimum value of the primary-side sensed current in an ON section of the main switch, T_{dmg} is a time from an OFF point of the main switch calculated by the time calculating unit to a point that the secondary-side current becomes zero, and Lₘ is a value of a primary-side magnetized inductance.

5. The PWM control circuit for the DC-DC converter according to claim 4, wherein a minimum value of the primary-side sensed current is ‘0’.

6. The PWM control circuit for the DC-DC converter according to claim 2, wherein the PWM control unit comprises:
an error amplification unit configured to amplify an error between the secondary-side output voltage calculated by the calculating unit and a reference voltage;
a duty determination unit configured to compare the output signal of the error amplification unit with a reference wave type signal to determine a duty; and
a switch driving unit configured to receive the output of the duty determination unit to apply a PWM control signal to the main switch.

7. The PWM control circuit for the DC-DC converter according to claim 1, further comprising a main switch configured to perform an ON-OFF operation according to the PWM control of the control unit.

8. The PWM control circuit for the DC-DC converter according to claim 1, wherein the PWM control circuit for the DC-DC converter is a flyback converter control circuit.

9. The PWM control circuit for the DC-DC converter according to claim 2, wherein the PWM control circuit for the DC-DC converter is a flyback converter control circuit.

10. A flyback converter comprising:
a transformer unit provided with a primary-side winding, a secondary-side main winding and a secondary-side auxiliary winding;
a main switch connected to the primary-side winding to perform an ON-OFF operation and transmit a primary-side input voltage to the transformer unit;
a secondary output unit connected to the secondary-side main winding of the transformer unit to provide a secondary-side output;
a current sensing unit configured to sense a primary-side current;
a zero-current detecting unit configured to detect a zero-current from the secondary-side auxiliary winding;
a time calculating unit configured to receive a control signal of the main switch and an output signal of the zero-current detecting unit to calculate a time from an OFF point of the main switch to a point that the secondary-side current becomes zero; and
a control unit configured to receive an output signal of the current sensing unit and time information produced by the time calculating unit to calculate a secondary-side output voltage and perform PWM control with respect to the main switch according to the calculated secondary-side output voltage.

11. The flyback converter according to claim 10, wherein the control unit comprises:
a calculating unit configured to receive the output signal of the current sensing unit and the time information produced by the time calculating unit to calculate a secondary-side output voltage; and
a PWM control unit configured to perform PWM control with respect to the main switch according to the secondary-side output voltage calculated by the calculating unit.

12. The flyback converter according to claim 11, wherein the calculating unit comprises a divider configured to divide the signal information obtained from the output of the current sensing unit by the time information produced from the time calculating unit.

13. The flyback converter according to claim 11, wherein the secondary-side output voltage Vₒᵤₜ is calculated according to the following equation
Vₒᵤₜ=n×((I_{cspeak}−I_{csmin})×Lₘ)/T_{dmg}
wherein n is a winding ratio between a primary-side winding and a secondary-side main winding, I_{cspeak} is a peak value of a primary-side sensed current, I_{csmin} is a minimum value of the primary-side sensed current in an ON section of the main switch, T_{dmg} is a time from an OFF point of the main switch calculated by the time calculating unit to a point that the secondary-side current becomes zero, and Lₘ is a value of a primary-side magnetized inductance.

14. The flyback converter according to claim 11, wherein the PWM control unit comprises:
an error amplification unit configured to an error between the secondary-side output voltage calculated by the calculating unit and a reference voltage;
a duty determination unit configured to compare an output signal of the error amplification unit with a reference wave type signal to determine a duty; and
a switch driving unit configured to receive an output of the duty determination unit to apply a PWM control signal to the main switch.

15. A method of controlling a PWM of a DC-DC converter comprising:
a current sensing step of sensing a primary-side current;
a zero current detecting step of detecting a zero-current from a secondary-side auxiliary winding;
a time calculating step of receiving a main switch control signal and a signal detected by the zero current detecting step and calculate a time from an OFF point of a main switch to a point that a secondary-side current becomes zero; and
a control step of receiving an output signal sensed and output in the current sensing step and time information produced in the time calculating step to calculate a secondary-side output voltage and perform PWM control with respect to the main switch according to the secondary-side output voltage.

16. The method according to claim 15, wherein the control step comprises:
a calculating step of receiving the output signal sensed and output in the current sensing step and the time information produced in the time calculating step to calculate the secondary-side output voltage; and
a PWM control step of performing the PWM control with respect to the main switch according to the secondary-side output voltage calculated in the calculating step.

17. The method according to claim 16, wherein, in the calculating step, the secondary-side output voltage Vₒᵤₜ is calculated according to the following equation
Vₒᵤₜ=n×((I_{cspeak}−I_{csmin})×Lₘ)/T_{dmg}
wherein n is a winding ratio between a primary-side and a secondary-side, I_{cspeak} is a peak value of a primary-side sensed current, I_{csmin} is a minimum value of the primary-side sensed current in an ON section of the main switch, T_{dmg} is a time from an OFF point of the main switch calculated by the time calculating unit to a point that the secondary-side current becomes zero, and Lₘ is a value of a primary-side magnetized inductance.

18. The method according to claim 15, wherein the method of controlling the PWM of the DC-DC converter is a flyback converter control method.

19. The method according to claim 16, wherein the method of controlling the PWM of the DC-DC converter is a flyback converter control method.
